(19) United States
(12) Patent Application Publication
(10) Pub. No.: US 2018/0319096 A1
(43) Pub. Date: Nov. 8, 2018

(54) WELDING APPARATUS FOR AUTOMATED WELDING OF PLASTIC COMPONENTS

(71) Applicant: AMT Group Bahamas Ltd., Nassau (BS)

(72) Inventor: Gregory John Dobbyn, Creedmoor, NC (US)

(21) Appl. No.: 15/968,295

(22) Filed: May 1, 2018

Related U.S. Application Data
(60) Provisional application No. 62/500,305, filed on May 2, 2017.

(51) Int. Cl. B29C 65/00; B29C 65/52

(52) U.S. Cl. CPC B29C 66/863; B29C 65/524; B29C 66/934; B29C 66/9161; B29C 66/9121; B29C 66/92211

(57) ABSTRACT

The present invention relates to, in general, a welding end effector apparatus configured for welding a plastic component. The welding end effector apparatus typically comprises a frame structure supporting a welding tip. The welding end effector apparatus further comprises a plastic weld rod feeder apparatus configured for delivering a plastic weld rod to the welding tip. The welding tip is configured to deposit at least partially deformed plastic weld rod onto the plastic component for welding the plastic component. The frame is configured to operatively couple the welding end effector to a multi-axis robotic arm for welding the component.

### CROSS-REFERENCE TO PRIORITY APPLICATION

This application claims the benefit of U.S. Provisional Patent Application Ser. No. 62/500,305 entitled “Welding Apparatus for Automated Welding of Plastic Components” (filed May 2, 2017), which is hereby incorporated by reference in its entirety.

### FIELD

This application relates generally to the field of apparatuses and methods for automated welding of plastic components.

### BACKGROUND

In general plastic welding has limited functionality and fails to provide the desired plastic welds. As such, there is a need for apparatuses that are configured for automated welding of plastic components.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention relate to a welding end effector apparatus for welding a plastic component. Typically, in various embodiments of the invention, the welding end effector apparatus comprises: a welding tip; a frame structure supporting the welding tip; and a plastic weld filler supply configured to supply plastic weld filler for plastic welding. Typically, the welding tip is configured to deposit the plastic weld filler onto a plastic component for welding the plastic component.

In some embodiments, or in combination with any of the embodiments herein, the frame structure comprises a tool flange. Moreover, the tool flange is configured to operatively couple the welding end effector to a multi-axis robotic arm. In some instances, the multi-axis robotic arm is configured to position the welding tip along a plurality of degrees of freedom for automated welding of the plastic component.

In some embodiments, or in combination with any of the embodiments herein, the plurality of degrees of freedom comprise at least a first linear translation direction, a second linear translational direction and a first angular rotational direction.

In some embodiments, or in combination with any of the embodiments herein, the welding end effector apparatus further comprises a heating mechanism.

In some embodiments, or in combination with any of the embodiments herein, the heating mechanism comprises an electrical heating element.

In some embodiments, or in combination with any of the embodiments herein, heating mechanism comprises a hot gas source.

In some embodiments, or in combination with any of the embodiments herein, the heating mechanism comprises a first hot gas guide configured for delivering hot gas to the welding tip. Moreover, the plastic weld filler may be a plastic weld rod. The welding tip is typically configured to direct hot gas and the plastic weld rod onto the plastic component for welding the plastic component.

In some embodiments, or in combination with any of the embodiments herein, the heating mechanism comprises a second hot gas guide configured for delivering hot gas to the plastic weld supply.

In some embodiments, or in combination with any of the embodiments herein, the plastic weld filler supply comprises: a weld rod feeder for delivering a plastic weld rod to a welding rod guide. The weld feeder rod further comprises: a toothed shaft configured for moving the plastic weld rod in a first direction towards the welding rod guide; a motor coupled to the toothed shaft, via a gear train, for turning the toothed shaft; and a tensioning apparatus comprising one or more force feed rollers configured for applying a predetermined pressure to the plastic weld rod located between the toothed shaft and the one or more force feed rollers. Typically, the welding rod guide is configured to direct the plastic weld rod into the welding tip.

In some embodiments, or in combination with any of the embodiments herein, the welding end effector apparatus further comprises a cutting mechanism to cut the plastic weld rod. The cutting mechanism further comprises (i) a cutting body comprising an actuation mechanism, wherein the actuation mechanism comprise at least one of a pneumatic actuation mechanism, an electronic actuation mechanism and an electro-mechanical actuation mechanism; and (ii) one or more cutting blades that are configured to cut the plastic weld rod. Typically, the actuation mechanism is configured to actuate the one or more cutting blades to cut the plastic weld rod, and the one or more cutting blades are configured to cut the plastic weld rod between a first portion of the plastic weld rod located at the welding rod guide and a second portion of the plastic weld rod located at the weld rod feeder.

In some embodiments, or in combination with any of the embodiments herein, the one or more cutting blades are configured to cut the plastic weld rod between the weld rod feeder and the welding tip, or between a first portion of the plastic weld rod located at the welding rod guide and a second portion of the plastic weld rod located at the weld rod feeder.

In some embodiments, or in combination with any of the embodiments herein, the welding end effector apparatus further comprises a hot gas mechanism configured to deliver hot gas to the welding rod guide.

In some embodiments, or in combination with any of the embodiments herein, the welding end effector apparatus further comprises a force sensor configured to: sense at least one welding parameter comprising welding speed, welding pressure at the welding tip and welding path of the welding tip; and transmit a feedback signal comprising the at least one welding parameter sensed to a controller device. Typically, the force sensor is configured to sense the at least one welding parameter along a plurality of degrees of freedom.

In some embodiments, or in combination with any of the embodiments herein, the invention provides a plastic welding apparatus configured for automated plastic welding. Here the plastic welding apparatus comprises: a robotic arm; and a welding end effector operatively coupled to the robotic arm. The welding end effector further comprises: a welding tip; a frame structure supporting a welding tip; and a plastic weld filler supply configured to supply plastic weld filler for plastic welding. Typically the welding tip is configured to deposit the plastic weld filler onto a plastic component for welding the plastic component.

In some embodiments, or in combination with any of the embodiments herein, the plastic welding apparatus further comprises a heating mechanism configured for heating the plastic weld filler; and a temperature sensor configured to transmit a temperature of the heating mechanism or weld filler. Typically, based on the sensed parameter, the heating mechanism is adjusted to control the temperature.

In some embodiments, or in combination with any of the embodiments herein, the plastic weld filler supply comprises a weld rod feeder apparatus and the plastic weld filler is a plastic weld rod. Typically, the plastic weld rod is configured to be at least partially deformed by the heating mechanism, the weld feeder apparatus is configured to deliver the plastic weld rod to the welding tip and the welding tip is configured to deposit the at least partially deformed plastic weld rod onto the plastic component for welding the plastic component.

In some embodiments, or in combination with any of the embodiments herein, the robotic arm comprises: a multi-axis robotic arm operatively coupled to the welding end effector, wherein the multi-axis robotic arm is configured to position the welding tip along a plurality of degrees of freedom for automated welding of the plastic component; and a controller device operatively coupled to the multi-axis robotic arm, wherein the controller device is configured to transmit control instructions to cause the multi-axis robotic arm to move the welding tip along a predetermined path.

In some embodiments, or in combination with any of the embodiments herein, the plastic welding apparatus further comprises a force sensor configured to transmit at least one sensed welding parameter to a controller device. Typically, based on the at least one sensed parameter, the controller device is configured to transmit control instructions to the multi-axis robotic arm to cause the multi-axis robotic arm to modify at least one of the movement of the welding tip and the position of the welding tip.

In some embodiments, or in combination with any of the embodiments herein, based on the at least one sensed parameter, the controller device is configured to transmit control instructions to the plastic weld supply to cause the plastic weld supply to modify dispensing of the plastic weld filler.

In some embodiments, or in combination with any of the embodiments herein, the invention provides a method for plastic welding of a plastic component comprising: executing, by a controller device having a processing device, computer readable code associated with a welding program for a plastic welding apparatus, wherein executing the computer readable code comprises determining a weld path comprising an origin point and an end point, wherein the plastic welding apparatus comprises a welding end effector operatively coupled to a robotic arm, the welding end effector comprising a welding tip, a plastic weld filler supply and a force sensor, and wherein the controller device is operatively coupled to the robotic arm and the welding end effector. The method further involves welding, by the welding end effector, a plastic component along the weld path based on instructions received from the controller device, wherein welding comprises: positioning, via the robotic arm, the welding tip at the origin position of the weld path; traversing, via the robotic arm, the welding tip along the weld path; and dispensing, via the plastic weld filler supply, plastic weld filler from the welding tip onto the plastic component during traversing the weld path, wherein dispensing further comprises heating the plastic weld filler using a heating mechanism of the welding end effector. Moreover, the method further comprises determining, by the force sensor, the welding parameter during the welding by the welding end effector; receiving, at the controller device, a feedback signal comprising the determined welding parameter from the force sensor; processing the feedback signal to determine whether the welding of the plastic component meets desired welding parameters; in response to determining that the feedback signal does not meet the welding parameters, transmitting control instructions from the controller device to modify the welding of the plastic component, wherein modifying the welding of the plastic component comprises at least one of: (i) traversing the welding tip, via the robotic arm, along a modified weld path, (ii) modifying the dispensing of the plastic weld filler using the plastic weld filler supply, and (iii) modifying the heating the plastic weld filler using the heating mechanism; and stopping the welding of the plastic component based on determining that the welding tip is located at the end point of the welding path.

### BRIEF DESCRIPTION OF THE DRAWINGS

For a more complete understanding, reference should now be had to the embodiments shown in the accompanying drawings and described below.

FIG. 1a illustrates a perspective view of a welding end effector apparatus, in accordance with some embodiments of the invention;

FIG. 1b illustrates a perspective view of a welding end effector apparatus, in accordance with some embodiments of the invention;

FIG. 2a illustrates a left side view of the welding end effector apparatus of FIG. 1a, in accordance with some embodiments of the invention;

FIG. 2b illustrates a left side perspective view of the welding end effector apparatus of FIG. 1b, in accordance with some embodiments of the invention;

FIG. 3a illustrates a right side view of the welding end effector apparatus of FIG. 1a, in accordance with some embodiments of the invention;

FIG. 3b illustrates a right side perspective view of the welding end effector apparatus of FIG. 1b, in accordance with some embodiments of the invention;

FIGS. 4a and 4b illustrate a perspective views of a plastic welding apparatus having the welding end effector apparatus in FIGS. 1a-1b, in accordance with some embodiments of the invention;

FIG. 5 illustrates an automated plastic welding system environment, in accordance with some embodiments of the invention; and

FIG. 6 illustrates a high level process flow for automated plastic welding, in accordance with some embodiments of the invention.

### DETAILED DESCRIPTION

The present system and method will now be described more fully hereinafter with reference to the accompanying drawings, in which preferred embodiments are shown. The system and method may, however, be embodied in many different forms and should not be construed as being limited to the embodiments set forth herein. Rather, these embodiments are provided so that this disclosure will be thorough and complete, and will fully convey the scope of the system and method to those skilled in the art. In the drawings, like numbers refer to like elements throughout.

Certain terminology is used herein for convenience only and is not to be taken as a limitation on the embodiments described. For example, words such as “top”, “bottom”, “upper,” “lower,” “left,” “right,” “horizontal,” “vertical,” “upward,” and “downward” merely describe the configuration shown in the figures or the orientation of a part in the installed position. Indeed, the referenced components may be oriented in any direction and the terminology, therefore, should be understood as encompassing such variations unless specified otherwise. Throughout this disclosure, where a process or method is shown or described, the method may be performed in any order or simultaneously, unless it is clear from the context that the method depends on certain actions being performed first.

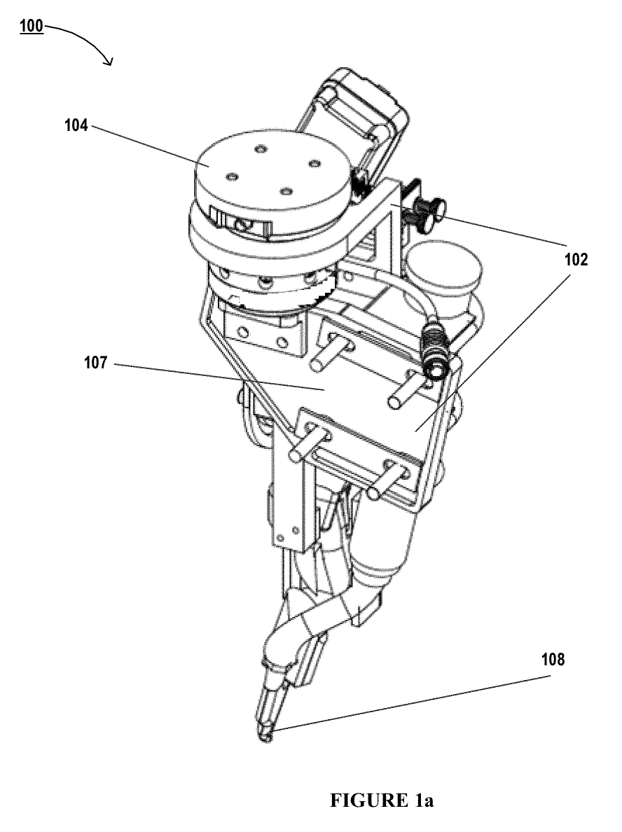

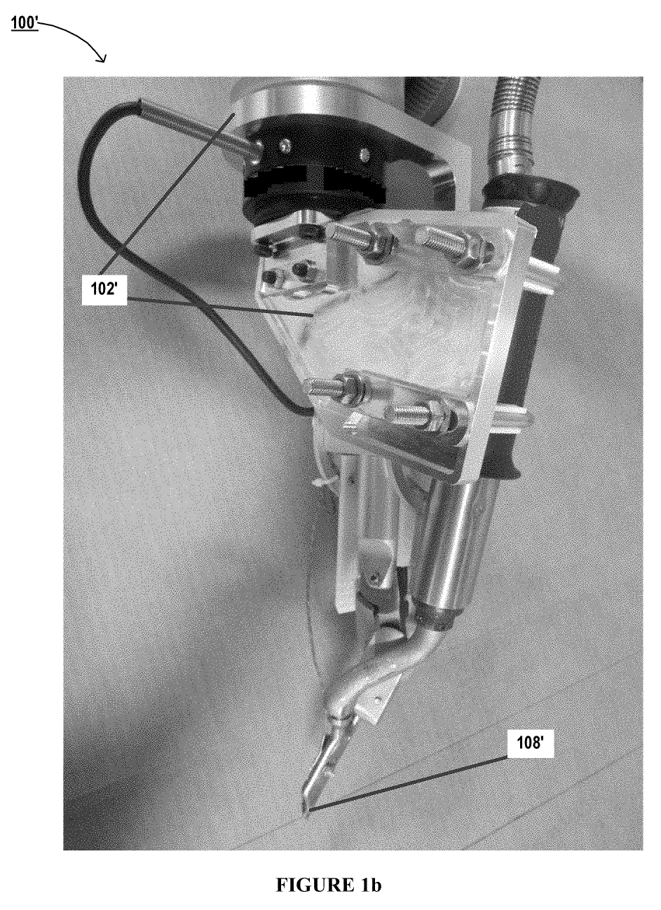

In general, the present invention is directed to a plastic welding apparatus for automated welding of plastic components. The plastic welding apparatus typically comprises a welding end effector apparatus, a multi-axis robotic arm, and a controller device. The welding end effector apparatus is configured to weld one or more joints of a plastic component, via a welding tip of the welding end effector apparatus. The multi-axis robotic arm is typically operatively coupled to the welding end effector apparatus, and is configured to position the welding end effector apparatus, and the welding tip in particular, along a plurality of degrees of freedom. Furthermore, the control device (e.g., one or more control devices) is operatively coupled to the multi-axis robotic arm and/or the welding end effector apparatus, and is configured to control, monitor, modify and operate the multi-axis robotic arm and/or the welding end effector apparatus. For example, the controller device may execute computer readable program code comprising welding instructions, and consequently cause the multi-axis robotic arm to position the welding end effector apparatus along a welding path associated with the plastic component, cause the welding end effector apparatus to weld the plastic component in accordance with certain weld parameters, receive and analyze dynamic feedback from one or more sensor devices, automatically and in real time, cause modification of the functioning of the multi-axis robotic arm and/or the welding end effector apparatus, and perform other functions, all of which will be described in further detail herein. The features of various embodiments of the plastic welding apparatus 1 are described with respect to FIGS. 1a to 6 herein. In particular, the features of various embodiments of the welding end effector apparatus 100 are described with respect to FIGS. 1a to 3b.

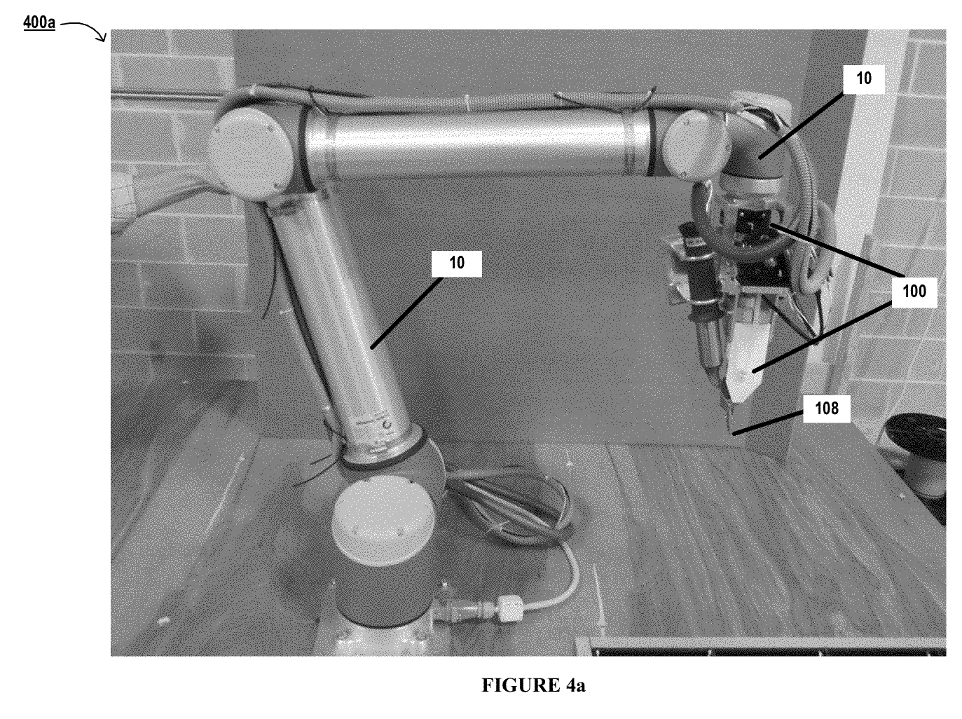

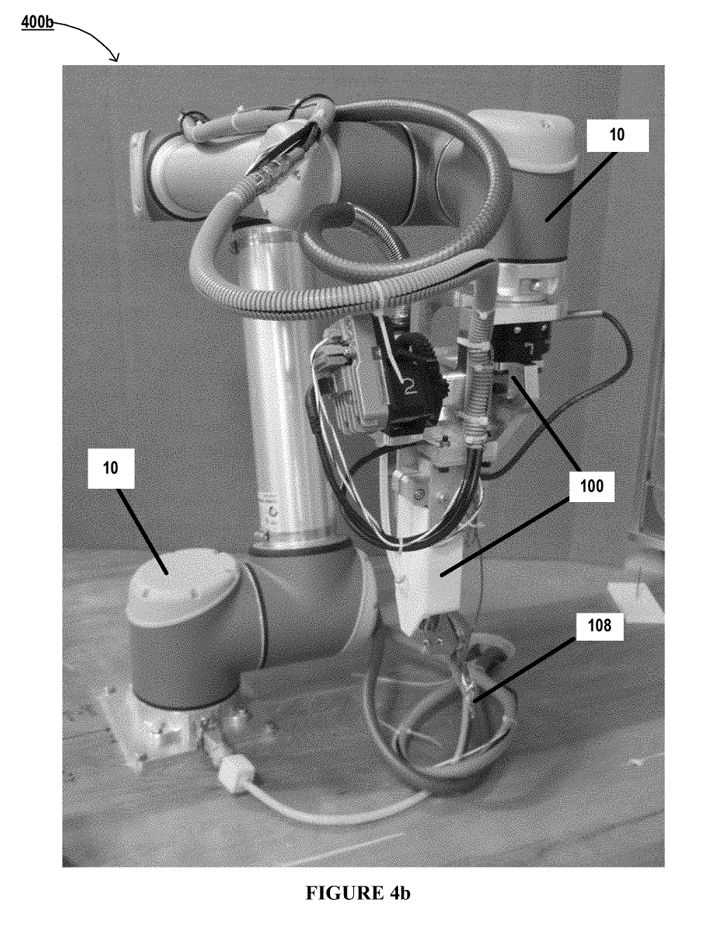

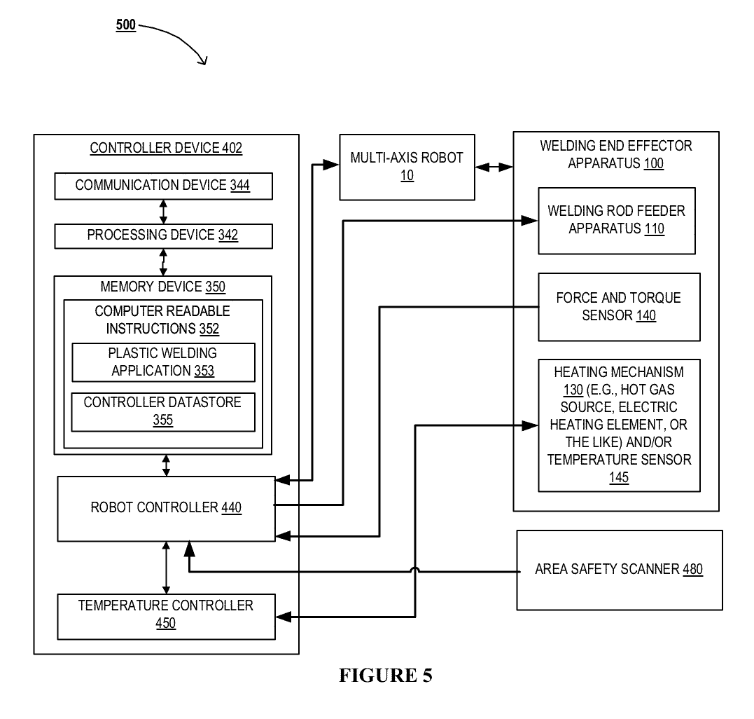

Referring now to FIG. 1a, a perspective view of a welding end effector apparatus 100 is illustrated, in accordance with some embodiments of the invention. Typically, the welding end effector apparatus 100 is configured for welding plastic components (e.g., two plastic components together, a first portion to a second portion of a plastic component, or the like). Furthermore, the welding end effector apparatus 100 is configured to be operatively coupled to a multi-axis robotic arm 10, as will be described in further detail later, and as illustrated in some embodiments in FIGS. 4a-4b and 5). In some embodiments, the welding end effector apparatus 100 comprises a frame structure 102. The frame structure 102 is configured to provide structural support to the welding end effector apparatus 100, and to one or more components (such as a welding tip 108) of the welding end effector apparatus 100. In some instances, the frame structure 102 is configured to operatively couple one or more components of the welding end effector apparatus 100 together. Furthermore, the frame structure 102 is configured to support a welding tip 108.

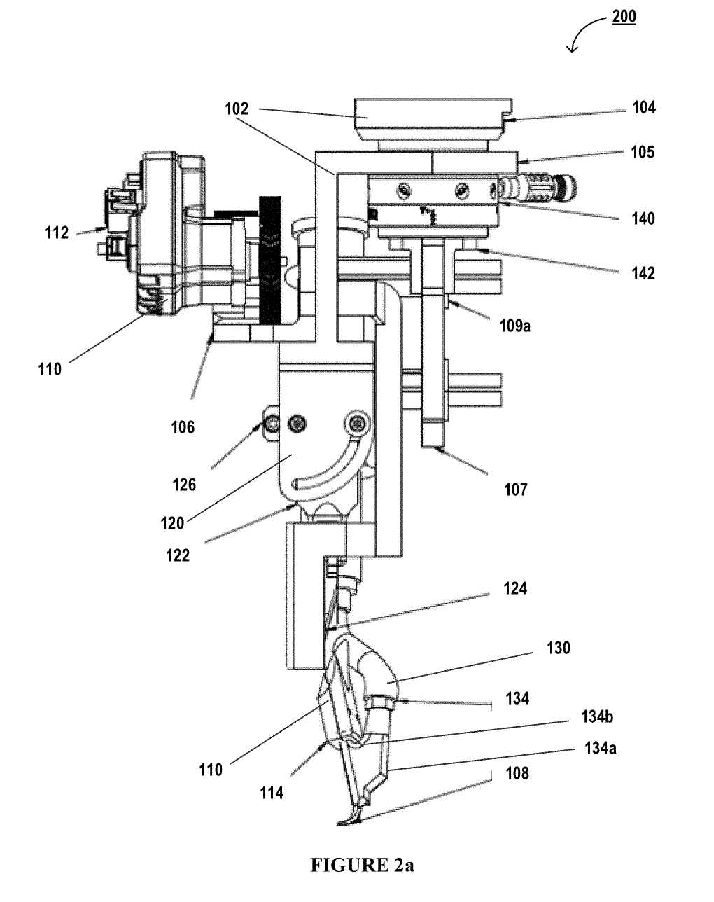

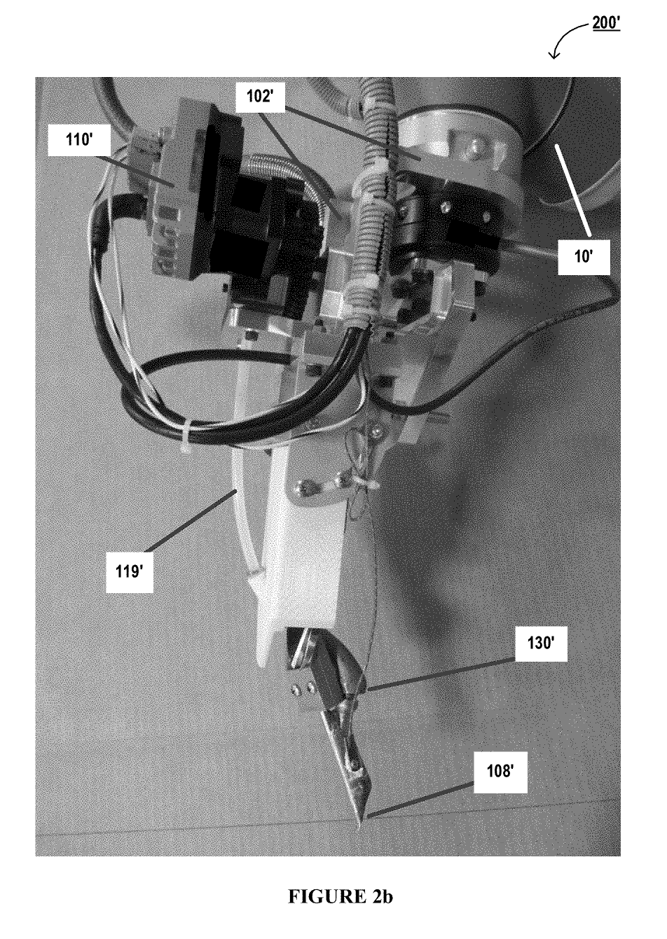

In some embodiments, the frame structure 102 provides structural support for ancillary equipment utilized for plastic welding of components, in some instances. Here, the frame structure 102 is configured to prevent unwarranted or adverse forces or other influences, caused by the ancillary equipment, from affecting a force torque sensor 140 (illustrated in FIG. 2a) of the plastic welding end effector apparatus 100. In some instances the frame structure 102 comprises a welder support plate 107, as illustrated. Typically, the welder support plate 107, either alone or together with a totem bracket 142 (illustrated in FIG. 2a) structured for operatively connecting the force torque sensor 140 to the apparatus 100 provides a force transfer bridge, thereby communicating/conveying welding forces from the welding tip 108 to the force torque sensor 140. Moreover, in some embodiments, the frame structure 102 provides separation of unsprung weight from sprung weight (e.g., that of the welder support plate 107).

The welding tip 108 is typically configured for welding a plastic component, for example, by depositing or otherwise positioning a plastic weld filler and/or hot gas on the plastic weld filler and/or plastic component, as will be described in detail later. In some embodiments, the hot gas is hot air, for example, air heated to a predetermined temperature. In some embodiments, the hot gas may comprise an inert gas for example, an inert gas heated to a predetermined temperature. The plastic component typically comprises two or more parts that form a joint that requires a plastic weld. The two or more parts may be formed out of the same materials (for example, a same type of plastic) or different materials (for example, one part made of acrylic and another made of poly(vinyl chloride), or other combinations of plastic materials). The plastic component may comprise one or more of synthetic plastic compounds, semi-synthetic plastic compounds, organic polymers, composites, reinforced plastics, plastic-metal composites and other suitable materials. As non-limiting examples, the plastic component, or one or more parts of the plastic component, may be made of polypropylene (PP), polycarbonate (PC), polyvinyl chloride (PVC), Low-density polyethylene (LDPE), Polystyrene (PS), Acrylonitrile butadiene styrene (ABS), fiber-reinforced plastics, metal matrices, metal composites, acrylics, Polyethylene terephthalate (PET), High-density polyethylene (HDPE), High impact polystyrene (HIPS), Polyethylene/Acrylonitrile Butadiene Styrene (PE/ABS), Silicone, Polyetheretherketone (PEEK), polyamides, acetates, and Nylon.

In some embodiments, the frame structure 102 further comprises a tool flange 104 configured to operatively couple the welding end effector apparatus 100 to a multi-axis robotic arm to form a plastic welding apparatus, as illustrated in some embodiments of the invention in FIGS. 4a-4b and 5. In some embodiments, the tool flange 104 is configured to allow interchangeability between various robotic arms and hence, is configured to operatively couple the welding end effector apparatus 100 to multiple types of arms. In some embodiments, the tool flange 104 comprises a standard tool plate. In some embodiments, the tool flange 104 is configured for automatic interchange, securing and detachment of the welding end effector apparatus 100 and a robotic arm, based on receiving instructions from a controlling device.

In embodiments of the present invention, the tool flange 104 operatively couples the welding end effector apparatus 100 and the robotic arm 10 such that, the multi-axis robotic arm is configured to position or move the welding end effector apparatus 100 along a plurality of degrees of freedom. In some embodiments, the plurality of degrees of freedom comprise movement along at least a first linear translational direction and a second linear translational direction. For example, the multi-axis robotic arm 10 is configured to at least position or move the welding tip at any point in a two dimensional plane. In some embodiments, the plurality of degrees of freedom comprise movement along at least the first linear translational direction, the second linear translational direction and a third linear translational direction. For example, the multi-axis robotic arm 10 is configured to at least position or move the welding tip at any point in a three dimensional space. In some embodiments, the plurality of degrees of freedom comprise movement along at least the first linear translational direction, the second linear translational direction and at least a first angular rotation direction (for example, angular rotation along the first, second and/or third linear translational direction). Typically, the multi-axis robotic arm is configured to position or move the welding end effector apparatus 100 along six degrees of freedom. For example, along the three independent, and typically mutually perpendicular, linear translation directions and along three independent angular rotation directions. In some embodiments, the multi-axis robotic arm 10 comprises one or more joints and is configured to position or move the welding end effector apparatus 100 along seven degrees of freedom or more. In some embodiments, the multi-axis robotic arm 10 comprises one or more joints and is configured to position or move the welding end effector apparatus 100 along fewer than six degrees of freedom.

The multi-axis robotic arm 10 is typically configured for multiple degrees of freedom, and a suitable combination of the degrees of freedom and appropriate dimensional value for each motion is typically employed (for example, based on control instructions received from a controlling device) to perform one or more welding operations/motions on the plastic component. In this way, in some instances, the welding tip 108 in conjunction with the multi-axis robotic arm is configured to weld, automatically, multiple sides/faces of the plastic component (for example, 5 mutually perpendicular sides/faces, one or more inner/annular sides, and/or the like), at varying depths at each of the sides based on the application, without requiring the plastic component, a work table holding the plastic component, the welding end effector apparatus 100, and/or the multi-axis robotic arm 10 to be unduly repositioned, replaced and/or otherwise excessively rearranged for welding the plastic component.

The welding end effector apparatus 100, and the frame structure 102 in particular, may be constructed out of materials such as stainless steel, carbon steels, suitable metals, alloys, plastics, composites, natural or synthetic materials, polymers and/or the like. The materials may be chosen for the specific application based on their durability, strength, ductility/malleability, weight, rigidity/flexibility, operative temperature ranges, durability, resistance to fatigue and creep, magnetic properties and the like. Furthermore, based on the application, the materials may be chosen for their corrosion resistance and chemical stability.

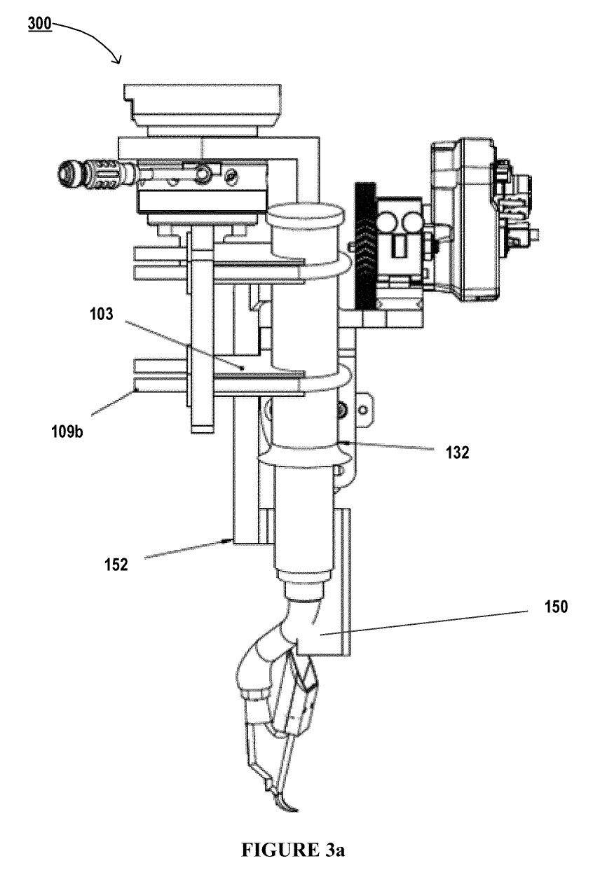

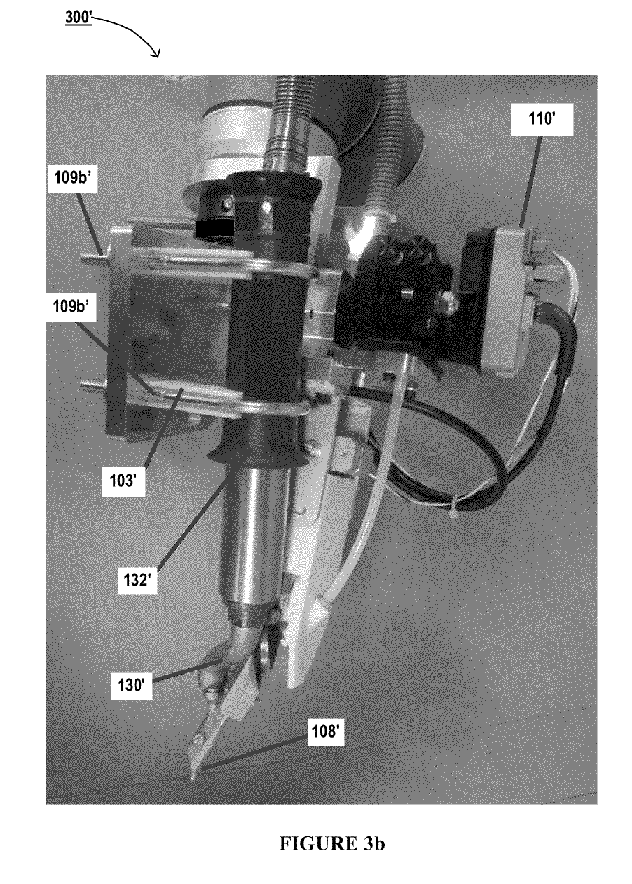

As discussed previously, the plastic welding apparatus 1 described herein, typically comprises a welding end effector apparatus 100, a multi-axis robotic arm 10, and a controller device 402 (as will be described later, and as illustrated in some embodiments in FIG. 5). The welding end effector apparatus 100 is configured to weld one or more joints of a plastic component, via a welding tip 108 of the welding end effector apparatus 100. Generally, the welding end effector apparatus comprises a plastic weld filler supply 110, a heating mechanism 130, and the weld tip 108 (as will be described later, and as illustrated in some embodiments in FIGS. 2a-2b and 3a-3b). The plastic weld filler supply 110 is configured for supplying/delivering a plastic weld filler (e.g., a plastic weld rod, plastic wire, injected molded plastic, heated plastic chips, powder, or the like) to the welding tip 108 for appropriate deposition/application of the plastic weld filler on the plastic component to be welded. The plastic weld filler is typically heated by the heating mechanism 130, before, during and/or after application of the weld filler onto the plastic component. The heating mechanism 130 may comprise one or more of an electrical heating mechanism, a hot gas heating mechanism, a hot gas coil, a hot gas source, or the like. The controller device 402 is typically configured to control and modify the functioning of the robotic arm 10, the welding end effector apparatus 100, and specifically the plastic weld filler supply 110 and a heating mechanism 130. For example, the controller device 402 may cause the plastic weld filler supply to dispense the weld filler to the welding tip 108, cause the heating mechanism 130 to heat the weld filler to a predetermined temperature, and the like, at a time (e.g., predetermined or based on feedback from the welding process) during the plastic welding operation.

The plastic welding apparatus 1 comprises one or more sensor devices. In some embodiments the plastic welding apparatus 1 comprises a force torque sensor 140 and/or a temperature sensor located on the plastic welding end effector apparatus 100. These sensor devices are configured to sense, determine and/or monitor one or more welding parameters during the welding operation, such as, speed, force and torque along a plurality of degrees of freedom, temperature of the plastic weld filler, component, and/or adjacent location, back pressure from the weld location, and the like. These sensor devices are configured to transmit feedback signals comprising the sensed welding parameters to the controller device 402. Based on analyzing the feedback signals, the controller device 402 is configured to, dynamically and in real time, cause modification in the operations of the welding end effector apparatus 100, and specifically the plastic weld filler supply 110 and/or the heating mechanism 130, for example, by starting the operation, stopping the operation, modifying the parameters of the operation, and the like. These features are described in further detail below.

Referring now to FIG. 1b, a perspective view of a welding end effector apparatus 100′ is illustrated, in accordance with some embodiments of the invention. The functions and features of the welding end effector apparatus 100′ and its components described with respect to FIG. 1b are substantially similar to those described with respect to the welding end effector apparatus 100 of FIG. 1a. For example, as previously described with respect to FIG. 1a, the welding end effector apparatus 100′ is configured for welding plastic components, and is configured to be operatively coupled to a multi-axis robotic arm 10. As discussed, in some embodiments, the welding end effector apparatus 100′ comprises a frame structure 102′ configured to operatively couple one or more components of the welding end effector apparatus 100 together and configured to support a welding tip 108′. The welding tip 108′ is typically configured for welding a plastic component, for example, by depositing or otherwise positioning a plastic weld filler and/or hot gas on the plastic weld filler and/or plastic component, as alluded to previously.

The components and features of the welding end effector apparatus 100 are further described in detail with respect to FIGS. 2a and 3a (and/or FIGS. 2b and 3b). FIG. 2a illustrates a left side view of the welding end effector apparatus 100 illustrated in FIG. 1a, and FIG. 3a illustrates a right side view of the welding end effector apparatus 100 illustrated in FIG. 1a, in accordance with some embodiments of the invention. Similarly, FIG. 2b illustrates a left side perspective view of, for example, the welding end effector apparatus 100′ illustrated in FIG. 1b, and FIG. 3b illustrates a right side perspective view of the welding end effector apparatus 100′ illustrated in FIG. 1b, in accordance with some embodiments of the invention. As discussed previously, the welding end effector apparatus (100, 100′) comprises a welding tip (108, 108′) for providing a plastic weld suitable for welding the plastic component.

Furthermore, in one embodiment of the invention, as illustrated by FIG. 2a, the frame 102 comprises an angle plate 105 configured to operatively connect one or more components of the welding end effector apparatus 100 to the tool flange 104. The apparatus 100 may further comprise a welder support plate 107. The welder support plate 107 is typically configured to establish correct geometric relationships between the welding tip 108 and the plastic component being welded. In addition, the welding end effector apparatus 100 comprises a plastic weld filler supply 110, which in some embodiments may be a plastic weld rod feeder apparatus 110, configured for delivering a plastic weld rod to the welding tip 108. The plastic weld rod feeder apparatus 110 is configured to deliver the plastic weld rod, via the welding tip 108, at the plastic component for welding the component at a joint of the component. The plastic weld rod (otherwise described as a plastic filler rod) comprises a plastic material in the form of a wire, a rod, or any other suitable configuration, that is configured to be at least partially deformed for creating a plastic weld between the plastic components or portions thereof. In some instances, the plastic weld rod is a solid or substantially solid material, while in other instances it may be semi-solid, a slurry, a fluid, which may be formed into the plastic weld rod just before welding of the plastic component.

“Deformation” of the plastic weld, and specifically the plastic weld rod, as used herein may refer to modification of the shape, dimensions, physical properties, chemical properties, and/or characteristics of the plastic weld rod by application of external parameters and/or by varying the ambient conditions. Specifically, deformation of the plastic weld rod as used herein may further refer to deformation of the plastic weld rod due to application of heat (for example, heating the plastic weld rod using an electric heating means or using hot gas to a predetermined first temperature), deformation of the plastic weld rod due to application of mechanical force (for example, extruding/drawing or cutting the weld rod, applying tensile/shear/compressive stresses for plastic deformation (malleability and ductility of the rod), and the like), a combination of heat and mechanical forces (for example, thermoforming the plastic weld rod), or otherwise varying the shape, dimensions, physical properties, chemical properties, and/or characteristics of the plastic weld rod by application of external parameters or by varying the ambient conditions. As such, in some instances, the plastic weld rod is deformed at multiple locations (for example, at various locations within the plastic weld rod feeder apparatus 110, at the welding tip 108, and/or after or during deposition on the plastic component), with same, different or a combination of deformation types applied at each location, as will be described in detail below. Therefore, the plastic weld rod may be partially deformed at multiple locations, and cumulative partial deformations may result in the desired deformation. That said, the plastic weld rod is typically configured to be at least partially deformed at a predetermined first temperature (for example, heating the plastic weld rod using an electric heating means or using hot gas to the predetermined first temperature). The weld rod may be heated in one or more locations, as will be described in further detail herein.

In some embodiments, the material of the plastic weld rod is chosen such that the plastic weld rod, for example after welding at a joint of the plastic component, exhibits the same or substantially similar properties (for example, within a predetermined upper and lower threshold of desired property value) as the material(s) of the plastic component itself or its parts to be joined (such as, suitable illustrative materials of the plastic component previously discussed). In some embodiments, the plastic weld rod is the same material as the material(s) of the plastic component (such as, suitable illustrative materials of the plastic component previously discussed, for example with some additives). That said, in some embodiments, the material of the plastic weld rod is different from some or all of the parts at the joint of the plastic component. In some embodiments, the plastic weld rod is a thermoplastic weld rod. In some embodiments, the plastic weld rod is a spooled plastic welding rod or spline. As such, the plastic weld rod may be of suitable dimensions and a suitable cross-section (such as a circular, oval, hemispherical, triangular, square, rectangular, or any other cross-sectional shape, such as a polygonal shape or a curvilinear shape). In some embodiments, the material of the plastic weld rod is chosen based on minimal porosity of the weld rod to minimize voids in the weld at the component. In some embodiments, the plastic weld rod comprises Acrylonitrile butadiene styrene (ABS), High-density polyethylene (HDPE), Polyvinyl chloride (PVC), Low-density polyethylene (LDPE), Linear low-density polyethylene (LLDPE), Polypropylene (PP), Copolymers, Styrene, Polyethylene terephthalate (PETG), Chlorinated polyvinyl chloride (CPVC), Urethane, Polycarbonate (PC), Polyvinylidene fluoride (PVDF), and/or the like.

The plastic weld rod feeder apparatus 110 typically comprises a weld rod feeder 112 and a welding rod guide 114. The weld rod feeder 112 may be operatively coupled (e.g., mounted, or the like) to the apparatus 100 using a welding rod feeder bracket 106 of the frame 102. The weld rod feeder 112 is typically configured for at least delivering the plastic weld rod to the welding rod guide 114. The welding rod guide 114 is configured to direct the plastic weld rod into the welding tip 108.

In some embodiments, the weld rod feeder 112 comprises a toothed shaft coupled to a motor for moving (e.g., pushing or pulling) the plastic weld rod in a first direction towards the welding rod guide 114 and/or the welding tip 108 and/or moving (e.g., pushing or pulling) the plastic weld rod in a second opposite direction away from the welding rod guide 114 and/or the welding tip 108. The motor is typically operatively coupled to the toothed shaft, via a gear train, for turning the toothed shaft in a first rotation direction (for example, for moving the plastic weld rod in the first direction), and/or in a second rotation direction (for example, for moving the plastic weld rod in the second direction), and at a desired speed (e.g., a predetermined speed). The weld rod feeder 112 may advance the plastic weld rod into the welding rod guide 114 in the first direction and/or retract the plastic weld rod from the welding rod guide 114 in the second direction, either continuously, intermittently, or variably, based on receiving instructions from the controller device 402. The plastic weld rod feeder apparatus 110 further comprises, in some instances, a tensioning apparatus comprising one or more force feed rollers configured for applying a predetermined pressure to the plastic weld rod located between the toothed shaft and the one or more force feed rollers. The tensioning apparatus is typically configured to at least partially deform the weld rod, for example, by extruding the rod between the toothed shaft and the one or more force feed rollers based on application of suitable compressive/tensile forces. In addition, or alternatively, the tensioning apparatus may be operatively coupled adjacent to the welding tip 108 (e.g., at or near the welding tip 108) or adjacent a heating mechanism 130 (e.g., at or near the heating mechanism 130 or output of the heating mechanism), such that weld rod may be more easily deformed and/or may be deformed prior to being applied to the plastic component.

Furthermore, the weld rod feeder 112 or the apparatus 100 comprises a cutting mechanism 120 to suitably shear (e.g., cut, slice, stop of the flow of, or the like) the plastic weld rod, for example, at the completion of the automated welding operation, during the welding operation, or a predetermined time period before the completion of the welding operation (e.g., to remove excess waste in the weld rod). In some embodiments, the cutting mechanism 120 is a nipper mechanism, while in other embodiments the cutting mechanism comprises other types of cutting mechanisms. The cutting mechanism 120 typically comprises one or more actuation mechanisms, such as, a pneumatic actuation mechanism, an electric actuation mechanism, a hydraulic actuation mechanism, a magnetic actuation mechanism, an electronic actuation mechanism, an electro-mechanical actuation mechanism or the like, and/or suitable combinations thereof, to suitably actuate components such as blades, cutting edges, vanes, and the like, for shearing the plastic weld. In some embodiments, the cutting mechanism 120 comprises a cutting body 122 with a pneumatic actuation mechanism. In some embodiments, the cutting mechanism 120 comprises a cutting body 122 with an electric actuation mechanism. The pneumatic actuation mechanism (and/or other actuation mechanisms, such as, the electric actuation mechanism) is configured to actuate one or more cutting blades 124 of the cutting mechanism to suitable shear the plastic weld rod. The cutting body 122 and the cutting blades 124 may be operatively coupled using a cutting mount 126. In some embodiments, for example, as illustrated by FIG. 2a, the one or more cutting blades 124 are configured to cut the plastic weld rod between a first portion of the plastic weld rod located at the welding rod guide 114 and a second portion of the plastic weld rod located at the weld rod feeder 112. In some embodiments, the cutting mechanism 120 is configured for cutting the plastic weld rod between a first portion of the plastic weld rod located at the welding rod guide 114 and a second portion of the plastic weld rod located at the weld rod feeder 112. That said, in some embodiments, or in combination with the previous embodiment, the cutting mechanism 120 is configured for cutting the plastic weld rod at a location before the weld rod feeder 112, within the weld rod feeder 112, within the welding rod guide 114, at a location between the welding rod guide 114 and the welding tip 108, at the welding tip 108, or another suitable location. In other aspects of the invention pre-cut plastic weld rods may be fed into the weld rod feeder 112 such that the cutting mechanism 120 is not needed or used.

As an example of the use of the cutting mechanism 120, in some embodiments, the controller device 402 (for instance using one or more sensor devices) may determine, in real time, the completion of the welding operation or the imminent completion of the welding operation, for instance, determining that the welding tip 108 is currently located at, or near, an edge or end of the weld joint of the plastic component being welded. In response, the controller device may cause the cutting mechanism 120 to cut the plastic weld rod, for example, at a cutting location between a first portion of the plastic weld rod located at the welding rod guide 114 and a second portion of the plastic weld rod located at the weld rod feeder 112. In such instances, typically, a first excess length of the plastic weld rod exists between the cutting location and the welding tip 108, and, in some instances, a second excess length between the cutting location and the toothed shaft of the weld rod feeder 112. Here, the feeder apparatus 110 may continue to dispense the first excess length over the edge/end of the plastic component (which may then be trimmed off later) through the welding guide 114 in the first direction, and/or pull the second excess length in the second direction away from the welding guide 114. In some embodiments, the feeder apparatus 110 is configured to pull the first excess length in the second direction away from the welding guide 114, without dispensing it. As another example, in some embodiments, the controller device 402 may determine the first excess length. Here, the controller device 402 (for instance using one or more sensor devices) may determine, continuously and in real time, based on a current determined location of the welding tip, that the welding tip 108 requires to traverse an estimated remaining path to complete the welding operation, i.e., reach an edge or an end of the joint of the plastic component being welded. The controller device may further determine the length of the (straight or curvilinear) estimated remaining path. The controller device may cause the cutting mechanism 120 to cut the plastic weld rod, based on determining that the length of the estimated remaining path is same as the first excess length, or based on determining that the length of the estimated remaining path is lesser than the first excess length by a predetermined value. Alternatively, the desired lengths of the plastic weld rod may be predetermined and cut by the cutting mechanism 120 based on the programing of the controller device 402.

As previously discussed, the welding end effector apparatus 100 comprises a heating mechanism 130. In some embodiments, the heating mechanism 130 comprises an electrical heating element (not illustrated) for heating one or more portions of the apparatus 100, a first guide 134a, the welding tip 108, gas from a source, the plastic weld rod at one or more locations, the joint of the plastic component, or the like. For example, in some embodiments, the electric heating element of the heating mechanism 130 is configured to heat the welding tip 108 (for example, in the instances where the welding tip 108 is made from a metallic material), such that the plastic weld being dispensed from the welding tip 108 is heated from contact with the heated welding tip 108. As another example, in some embodiments or in combination with the previous embodiment, the electric heating element of the heating mechanism 130 is configured to heat the first guide 134a and/or the welding rod guide 114 (for example, in the instances where the first guide 134a and/or welding rod guide 114 are made from a metallic materials) to cause heating of plastic weld, in contact with the first air guide 134a and/or welding rod guide 114, as it is being dispensed.

In some embodiments, the heating mechanism 130 achieves heating of the one or more portions of the apparatus 100, the welding tip 108, gas from a source, the plastic weld rod at one or more locations, and/or the joint of the plastic component, using hot gas. In this regard, the heating mechanism 130 comprises a hot gas source 132 either within the apparatus 100 (as illustrated by FIG. 3a), or separate from the apparatus 100. In the instances, where the hot gas source 132 is a part of the apparatus 100, the hot gas source 132 may be supported by or coupled to the welder support plate 107, or another components of the apparatus 100, using a saddle bracket 103 illustrated in FIG. 3a. The U-bolt plate 109a is typically configured to secure the hot gas source 132 with the saddle bracket 103, together with a U-bolt 109b (as illustrated by FIG. 3a). The hot gas source 132 typically comprises gas heated to a first temperature (e.g., a predetermined first temperature, or desired temperature based on the feedback), which may be varied by the controller device, for example, based on analyzing feedback parameters. In some embodiments, the heating mechanism 130 comprises one or more hot gas guides 134. In some embodiments, the heating mechanism 130 comprises a first hot gas guide 134a configured for delivering hot gas (for example, heated to the first temperature, or heated to a second temperature with the second temperature being lower, higher or same as the first temperature) to the welding tip 108. The welding tip 108 is configured to direct the received hot gas to the plastic component, via the first hot gas guide 134a, for example, along with the plastic weld rod via the welding rod guide 114. Here, in some instances, a hot gas jet is produced from the welding tip 108 that is configured to soften or otherwise deform the parts of the plastic component to be joined, along their joint. In some instances, these thermally deformed parts of the plastic component may be joined by application of pressure with or without the plastic weld rod.

In other instances, the welding tip 108 is configured to direct the received hot gas to the plastic component, via the first hot gas guide 134a, together with the plastic weld rod via the welding rod guide 114. The hot gas jet from the first hot gas guide 134a is typically configured to soften or deform the plastic weld rod at the welding tip 108 (or as it is exiting the tip 108). In some instances, additionally, the hot gas jet from the first hot gas guide 134a is typically configured to soften or otherwise deform the parts of the plastic component to be joined, along their joint. This deformation of the plastic weld rod and/or the parts of the components enables the bonding of the parts at the joint, for example after cooling and hardening of the plastic weld rod deposited suitably in the weld joint. In some embodiments, during the welding process described above, the welding tip 108 may be maintained at a distance (e.g., predetermined distance) away from the surface of the component and/or the surface of the joint of the component. In some embodiments, the welding tip 108 is configured to be inserted to a predetermined depth into the weld joint or one or more defects or holes of the plastic component, thereby precluding the need for access to or the need to weld thick components from two opposite sides. Furthermore, in some embodiments, the heating mechanism comprises a second hot gas guide 134b configured for delivering hot gas (for example, heated to the first/second predetermined temperature, or heated to a third predetermined temperature with the third temperature being lower, higher or same as the first/second temperature) to the plastic weld rod guide 114. Here, system is configured to deform the plastic weld rod at an additional second location, for example, to help advancement of the plastic weld through the welding rod guide 114 and to enhance bonding after application of the weld. In some embodiments, and particularly in the instances where the plastic component comprises at least a portion of metallic components, such as a composite material, in addition to applying the weld filler/plastic weld rod and/or the hot gas at the plastic component, the welding tip 108 is configured to transmit electrical, ultrasonic, infrared and/or other signals to the plastic component, during the welding processes, for example, to heat the plastic component and/or the plastic weld.

Typically, the quality of the desired weld is affected by welding parameters such as welding temperature, welding rod feed rate, welding speed, welding pressure and welding path. These welding parameters are often interdependent, and together affect the quality of the weld, i.e., fusion of the weld, penetration of the weld and the like. Varying these parameters may be necessary to achieve the predetermined quality of weld. The present invention provides automated plastic welding of optimum quality by measuring the welding parameters, forces and welding pressures in real time, and accordingly varying the welding parameters in real time or near real time, to achieve optimal welds and without waste of the plastic components, which would not be possible in the absence of the present invention. For example, based on determining a high back pressure at the weld tip, the controller device may cause lowering the temperature of the plastic weld (for example, by transmitting control instructions to cause lowering the temperature of the electrical heating element or the hot gas source), and slow the feed rate for the welding rod (for example, by transmitting control instructions to the feeder apparatus 110) and slowing the welding speed (for example, by transmitting control instructions to the robotic arm).

Specifically, the welding end effector apparatus 100 or the robotic arm 10 of the plastic welding apparatus 1 typically comprises a force torque sensor 140, also referred to as a force sensor 140, for determining/measuring one or more welding parameters. In some embodiments, the force sensor 140 is configured to determine feedback or welding parameters (such as welding pressure applied onto the component, back pressure from the component at the tip 108, welding speed, welding forces, welding torques and the like) along six degrees of freedom (for example, force along linear directions Fₓ, F_{y}, F_{z}, and torque along angular directions τₓ, τ_{y}, τ_{z}). Based on analyzing the feedback the system may vary one or more parameters, such as welding force along a predetermined direction, to achieve optimal welding. As such, the force sensor 140 is configured to sense at least one welding parameter comprising welding speed, welding pressure at the welding tip and welding path of the welding tip 108, along a plurality of degrees of freedom, either continuously, intermittently or at predetermined time intervals. In response, the force sensor 140 is configured to transmit a feedback signal comprising the at least one welding parameter to a controller device, either continuously, intermittently or at predetermined time intervals. The apparatus 100 may further comprise a totem bracket 142 for operatively connecting the force sensor 140 to the apparatus 100.

In some embodiments, the welding end effector apparatus 100 further comprises a temperature sensor (not illustrated) for sensing the temperature of the heating mechanism, the temperature of the hot gas at one or more locations (such as, first, second and third predetermined temperatures), the temperature of the weld rods at one or more locations, or the like. For example, based on the sensed temperatures, the controller device may cause the heating mechanism to vary the temperature of the hot gas delivered at the welding tip 108.

As such, the multi-axis robotic arm 10 operatively coupled to the welding end effector 100 is configured to position the welding tip 108 along a plurality of degrees of freedom for automated welding of the plastic component. Furthermore, a controller device operatively coupled to the multi-axis robotic arm 10 is configured to transmit first control instructions that cause the multi-axis robotic arm to move the welding tip along a predetermined path with predetermined first set of parameters. In response to receiving feedback from the sensor devices comprising a force sensor 140, a temperature sensor, and/or a position sensor, the controller device is configured to transmit second control instructions to the multi-axis robotic arm 10, wherein the second control instructions are configured to cause the multi-axis robotic arm to modify at least one of the movement of the welding tip and the position of the welding tip, or the first set of parameters. In some instances, in response to receiving feedback from the sensor devices comprising a force sensor 140, a temperature sensor, and/or a position sensor, the controller device is configured to transmit third control instructions to the plastic weld rod feeder apparatus 110, the third control instructions being configured to cause the plastic weld rod feeder apparatus 110 to modify dispensing of the plastic weld rods from the plastic weld rod feeder 110 apparatus, for example hastening or slowing down the feed into the guide 114.

Referring now to FIG. 2b, a left side perspective view of a welding end effector apparatus 200′ is illustrated, in accordance with some embodiments of the invention. The functions and features of the welding end effector apparatus 200′ and its components described with respect to FIG. 2b are substantially similar to those described with respect to the welding end effector apparatus 200 of FIG. 2a (and/or the welding end effector apparatus (100, 100′) of Figures (1a, 1b)). For example, as previously described with respect to FIG. 2a, the welding end effector apparatus 200′ is configured for welding plastic components, and is configured to be operatively coupled to a multi-axis robotic arm 10′. As discussed previously, the welding end effector apparatus 200′ may comprise a frame structure 102′ supporting a plastic weld filler supply 110′, which in some embodiments may be a plastic weld rod feeder apparatus 110′, configured for delivering a plastic weld rod to the welding tip 108′. As such, as alluded to previously, the plastic weld may be at least partially deformed at multiple locations, for example, at various locations within the plastic weld rod feeder apparatus 110′, at the welding tip 108′, and/or after or during deposition on the plastic component, within a feed conduit 119′, or due to heated fluid supplied by the feed conduit 119′. Moreover, as discussed previously, the welding end effector apparatus 200′ may further comprise a heating mechanism 130′, a force torque sensor 140′ and/or other components described previously.

FIG. 3a illustrates a right side view of the welding end effector apparatus 100 illustrated in FIG. 1a, in accordance with some embodiments of the invention. The structure and functions of the apparatus 100 illustrated herein is substantially similar to those described previously, with respect to FIGS. 1a and 2a. FIG. 3a illustrates the hot gas source 132 supported by or coupled to the saddle bracket 103. Furthermore, the U-bolt 109b is illustrated, which is typically configured to secure the hot gas source 132 with the saddle bracket 103. In addition, FIG. 3a illustrates a cutter shield 150 that is operatively coupled to the frame 102 using a cutter shroud support 152. The cutter shield 150 is typically configured to protect and shield one or more components of the welding end effector apparatus 100 from damage due to hot gas, rebound molten plastic and other materials from the weld, or the like, and/or protect external features (including humans) from the cutting mechanism 120, hot gas, or the like. FIG. 3a further illustrates the cutter shield 150 being configured to protect the one or more cutting blades 124. In some embodiments the one or more cutting blades 124 are nipper blades.

Referring now to FIG. 3b depicting a right side perspective view of a welding end effector apparatus 300′ of the welding end effector apparatus 100′ illustrated in FIG. 1b, in accordance with some embodiments of the invention. The functions and features of the welding end effector apparatus 300′ and its components described with respect to FIG. 3b are substantially similar to those described with respect to the welding end effector apparatus 300 of FIG. 3a (and/or the welding end effector apparatus (100, 100′) of Figures (1a, 1b) and the welding end effector apparatus (200, 200′) of FIGS. 2a, 2b)). For example, as previously described, the welding end effector apparatus 300′ is configured for welding plastic components via a weld tip 108′, and is configured to be operatively coupled to a multi-axis robotic arm 10′. As discussed previously, the welding end effector apparatus 200′ may comprise a plastic weld filler supply 110′, a heating mechanism 130′, a force torque sensor 140′ and/or other components described previously. Moreover, FIG. 3b illustrates a hot gas source 132′ supported by or coupled to a saddle bracket 103′. Furthermore, a U-bolt 109b′ is illustrated, which is typically configured to secure the hot gas source 132′ with the saddle bracket 103′.

FIGS. 4a and 4b illustrate a perspective view of a welding apparatus having the welding end effector apparatus. Specifically, the FIGS. 4a and 4b illustrate the welding end effector apparatus 100 being coupled to the multi-axis robotic arm 10. The functions and features of the welding end effector apparatus 100 illustrated in FIGS. 4a and 4b are substantially similar to those described with respect to the welding end effector apparatus 100, of FIG. 1a (and/or the welding end effector apparatus (200, 200′) of FIGS. 2a, 2b) and/or the welding end effector apparatus (300, 300′) of FIGS. 3a, 3b)). For example, as previously described, the welding end effector apparatus 100 is configured for welding plastic components via a weld tip 108. As discussed previously, the multi-axis robotic arm 10 is configured to position the welding tip 108 along a plurality of degrees of freedom for automated welding of the plastic component. For instance, the multi-axis robotic arm 10 may position and/or spatially move the welding tip 108 from a first position 400a illustrated in FIG. 4a to another position 400b illustrated in FIG. 4b.

FIG. 5 illustrates an automated plastic welding system environment 500 for the embodiments described above. The system environment 500 (also referred to as the plastic welding apparatus 1) comprises a controller device 402 operatively coupled to the multi-axis robot 10, the welding end effector apparatus 100, and an area safety scanner 480. The controller device 402 typically includes a communication device 344, a processing device 342, and a memory device 350. The controller device 402 further comprises a robot controller 440 configured for transmitting control instructions to and controlling the multi-axis robot 10, the welding end effector apparatus 100, and feeder apparatus 110. The controller device 402 comprises a temperature controller 450 configured for transmitting control instructions to and controlling the hot gas source 132 (or the heating mechanism 130) and temperature sensor 145. As used herein, the term “processing device” generally includes circuitry used for implementing the communication and/or logic functions of the particular system. For example, the processing device 342 may include a digital signal processor device, a microprocessor device, and various analog-to-digital converters, digital-to-analog converters, and other support circuits and/or combinations of the foregoing. Control and signal processing functions of the controller device 402 are allocated between these processing devices according to their respective capabilities. The processing device may include functionality to operate one or more software programs based on computer-readable instructions for welding of components thereof, which may be stored in a memory device 350. In some embodiments, the processing device 342 transmits control instructions to and causes the robot controller 440 and/or temperature controller 450 to transmit one or more control instructions. In some embodiments, the robot controller 440 and/or temperature controller 450 are processing devices.

Typically, the processing device 342 is operatively coupled to the communication device 344 and the memory device 350. The processing device 342 uses the communication device 344 to communicate with the robot controller 440 and/or temperature controller 450, and hence the multi-axis robot 10, the welding end effector apparatus 100, the sensors (140, 145), the scanner 480, and/or other devices, either directly or over a network 500. As such, the communication device 344 generally comprises a modem, server, or other device for communicating with other devices on the network. The network may be a system specific distributive network receiving and distributing specific network feeds and identifying specific network associated triggers. The network 201 may also be a global area network (GAN), such as the Internet, a wide area network (WAN), a local area network (LAN), a telecommunication network, Near Field Communication (NFC) network or any other type of network or combination of networks. The network may provide for wireline, wireless, or a combination wireline and wireless communication between devices on the network.

As further illustrated in FIG. 5, the controller device 402 comprises a module 352 stored in the memory device 350, which in one embodiment includes computer-readable instructions for performing one or more steps of the automated welding operations described herein. In some embodiments, the memory device 350 includes data storage 355 (for example, a database or data repository) for storing compiled information regarding the welding operations. In some embodiments, the plastic welding application 353 comprises computer readable instructions that when executed by the processing device 342 cause the processing device 342 to perform one or more functions and/or transmit control instructions to the robot controller 440, the temperature controller 450, the robot arm 10, the welding end effector apparatus 100 and its components, and/or an area safety scanner 480. It will be understood that the plastic welding application 353 may be executable to initiate, perform, complete, and/or facilitate one or more portions of any embodiments described and/or contemplated herein, and specifically embodiments directed to welding operations.

An illustrative welding process is described herein. As an initial step, the processing device 342, for example, via the communication device 344, may cause the robot controller 440 to transmit control instructions to the multi-axis robot arm 10. The processing device 342 may perform this step based on receiving instructions from a user, based on detecting a plastic component to be welded and/or based on executing computer readable instructions 352 of the plastic welding application 353. The processing device 342 may then analyze one or more scanned parameters, determine the location of the weld, the weld path, degrees of freedom required, optimal weld parameters and the like, and cause the robot controller 440 to transmit these instructions to the multi-axis robot 10, for example, step-by-step based on determining completion of a preceding step. The multi-axis robot 10 may then cause the welding end effector apparatus 100, and particularly the welding tip 108, to traverse the determined weld path, based on the determined weld parameters. Furthermore, the processing device 342 may further cause the robot controller 440 to optimally control the plastic rod feeding performed by the welding rod feeder apparatus 110. In addition, the processing device 342 may further cause the temperature controller 450 to optimally control the temperature of the heating apparatus, for example the hot gas source 132. The device 402 may further receive feedback signals from the area safety scanner 480 and accordingly modify the weld path and/or weld parameters for safe welding.

Furthermore, while the welding operations are being performed, the processing device 342, via the robot controller 440 and the temperature controller, may receive feedback signals from the force and torque sensor 140 and/or the temperature sensor 145, respectively. The feedback signals comprise measured/sensed welding parameters described previously, and may be received continuously, periodically, intermittently or in response to transmitting a signal request to the sensors. The processing device 342 may then analyze the welding parameters from the feedback signal(s) and consequently transmit control instructions to, via the robot controller 440, (i) the multi-axis robot 10 to cause the robot to modify weld path and/or welding parameters, (ii) the welding rod feeder apparatus 110 to modify the feed rate, deformation and/or cutting of the plastic weld rods, and/or control instructions to, via the temperature controller 450, (iii) hot gas source 132 to modify the temperature of the hot gas, or otherwise to the heating mechanism 130 to change the welding temperatures.

As such, conventional methods of plastic welding involve manually welding one or more components. These methods fail to deliver consistently strong, precise and accurate welds, consistently and repeatedly. Moreover, various interdependent welding parameters (such as welding rod feed rate, welding speed, welding temperature, welding pressure, welding path and the like) cumulatively effect the strength, fusion, weld penetration and the overall strength of the weld. These operating parameters often differ from component to component, and also vary during the welding process, and drastically effect the quality of the weld. Conventional methods are deficient in accurately sensing and timely processing these welding parameters, which are vital in achieving optimal and strong welds in plastic components. Here, a welding parameter may be gauged or estimated, if at all, by the operator performing the welding manually. However, the operator is simply not able to accurately measure, process, and dynamically modify the weld in time, resulting in defective welds, welds of varying quality, and wasted components. As discussed previously, the present invention provides a plastic welding apparatus that alleviates the above deficiencies and delivers a comprehensive, precise, and dynamic welding apparatus for welding of plastic components, with repeatable results. For instance, the present invention provides multiple degrees of freedom at the welding tip (typically, six degrees of freedom) to suitably position the weld tip at predetermined accuracy and precision (for example, within a few microns, about 50-125 microns and the like), to achieve precise and accurate welds with minimal tolerances. For instance, the plastic welding apparatus of the present invention is configured to appropriately vary interdependent welding parameters (such as welding rod feed rate, welding speed, welding temperature, welding pressure, welding path and the like), dynamically and adaptively, such that their cumulatively effect results in the welds of a predetermined quality, depth of penetration, fusion and strength, for each plastic component. Furthermore, the control features of the present invention may be located away from the welding zone to minimize detrimental effects of exposure to welding conditions.

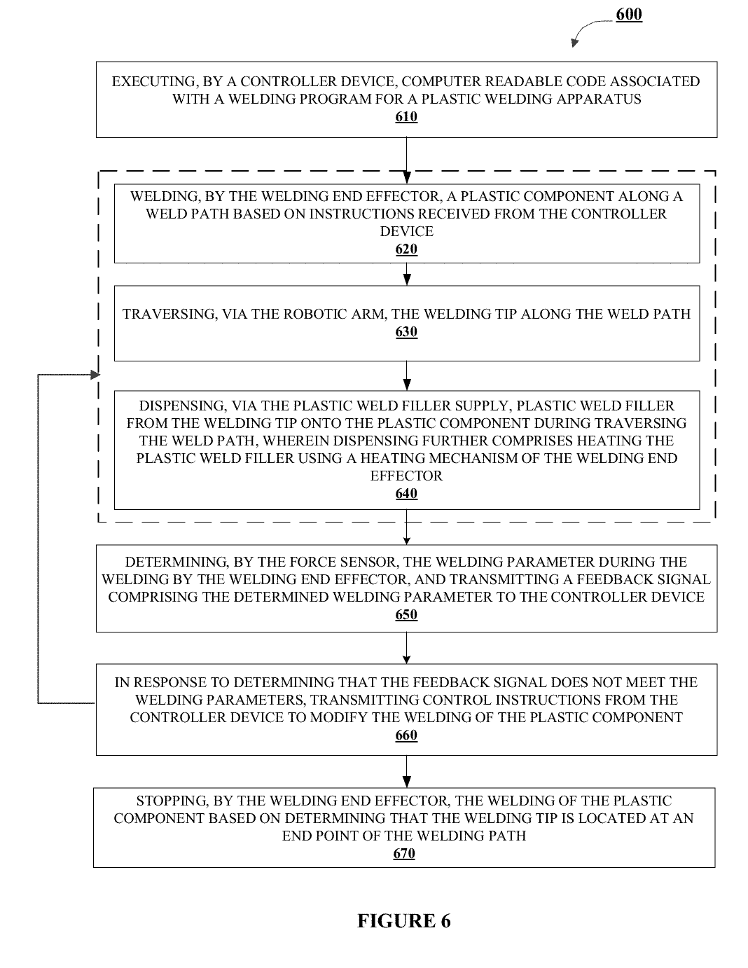

Referring now to FIG. 6, illustrating a high level process flow 600 for automated plastic welding using the plastic welding apparatus 1 described herein, in accordance with some embodiments of the invention. Initially, the controller device 402 may execute computer readable code associated with a welding program for the plastic welding apparatus, as indicated by step 610. In some instances, the computer readable code refers to the computer readable instructions 352 associated with the plastic welding application 353, and/or computer readable code received at the controller device 402. As discussed previously, the computer readable code may be executed by the processor 342 of the controller, and executing the code may cause the processor 342 to perform one or more functions, transmit control signals to other devices and the like. As such, the processor 342 may determine a weld path for welding of the component. The weld path typically comprises an origin point and an end point.

At step 620, welding of plastic component by the welding end effector apparatus 100, is commenced, for example, based on receiving instructions from the controller device. Initially, the welding tip at may be positioned at a “zero” or default location. The robotic arm 10, based on receiving instructions from the controller device 402, may then move the welding tip to the origin position of the weld path. As the welding process proceeds, the robotic arm 10 may traverse the welding tip 108 along the weld path, as indicated by step 630. Furthermore, as a part of the welding process, the plastic weld filler supply 110 (i.e., the plastic weld feeder apparatus 100) appropriately dispenses plastic weld filler (for example, the plastic weld rod material) from the welding tip onto the plastic component along the weld path, as indicated by step 640 and discussed in detail previously with respect to FIGS. 1a to 4b. Furthermore, the plastic weld filler may be heated by the heating mechanism 130 of the welding end effector 100, as previously described herein.

As the welding process steps 620-640 are being conducted, the force sensor 140 and/or the temperature sensor may determine one or more welding parameters and transmit a feedback signal comprising the sensed parameter to the controller device 402, as indicated by step 650. For example, the force sensor 140 may determine a welding parameter (for example, welding speed, back pressure and the like), and transmit the welding parameter to the controller device 402, either continuously, intermittently (for example, at predetermined periodic intervals of time), or based on receiving instructions from the controller device 402.

The controller device may then process the feedback signal to determine whether the welding of the plastic component meets desired welding parameters, weld quality, and the like. In this regard, the controller 402 may determine the combination of welding parameters required for achieving the desired weld quality, weld penetration, bonding and fusion, and other weld characteristics. The controller 402 may determine whether the sensed welding parameter (for example, the welding speed, welding path location, welding pressure), other interdependent welding parameters (for example, temperature of weld, temperature of the hot gas), and/or other welding functions (for example, the speed of dispensing the weld from the feeder 110, cutting of the weld rod by the nipping mechanism 120) need to be varied to achieve the desired weld characteristics, and further determine the extent/value by which they have to be varied. In response the controller device may transmit control instructions to modify, dynamically and in real-time, the welding of the plastic component based on the above, as indicated by step 660. For example, the controller 402 may modify the welding of the component by (i) traversing the welding tip, via the robotic arm, along a modified weld path, (ii) modifying the dispensing of the plastic weld filler using the plastic weld filler supply, (iii) modifying the heating the plastic weld filler using the heating mechanism, and/or the like. As such, the welding of the plastic component may be stopped, as indicated at step 670, based on determining that the welding tip is located at an end point of the welding location, and subsequently facilitate removal or repositioning of the plastic component.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, a software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: a non-transitory computer readable medium, an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It should be understood that “operatively coupled” or “operatively coupling,” when used herein, means that the components may be formed integrally with each other, or may be formed separately and coupled together. Furthermore, these terms may mean that the components may be formed directly to each other, or to each other with one or more components located between the components that are operatively coupled together. Furthermore, these terms may mean that the components are detachable from each other, or that they are permanently coupled together.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

While the present invention has been disclosed with reference to certain embodiments, numerous modifications, alterations and changes to the described embodiments are possible without departing from the sphere and scope of the present invention, as defined in the appended claim(s). Accordingly, it is intended that the present invention not be limited to the described embodiments, but that it has the full scope defined by the language of the following claims, and equivalents thereof.

Although specific embodiments have been illustrated and described herein, those of ordinary skill in the art appreciate that any arrangement which is calculated to achieve the same purpose may be substituted for the specific embodiments shown and that the embodiments herein have other applications in other environments. This application is intended to cover any adaptations, combinations or variations of the embodiments and elements described in the present disclosure. The following claims are in no way intended to limit the scope of the disclosure to the specific embodiments described herein. While the foregoing is directed to embodiments of a system and method for screen panel tracking, other and further embodiments may be devised without departing from the basic scope thereof, and the scope thereof is determined by the claims that follow.

What is claimed is:

1. A welding end effector apparatus for welding a plastic component, comprising:
a welding tip;
a frame structure supporting the welding tip; and
a plastic weld filler supply configured to supply plastic weld filler for plastic welding;
wherein the welding tip is configured to deposit the plastic weld filler onto a plastic component for welding the plastic component.

2. The welding end effector apparatus of claim 1, wherein the frame structure comprises a tool flange, wherein:
the tool flange is configured to operatively couple the welding end effector apparatus to a multi-axis robotic arm; and
the multi-axis robotic arm is configured to position the welding tip along a plurality of degrees of freedom for automated welding of the plastic component.

3. The welding end effector apparatus of claim 2, wherein the plurality of degrees of freedom comprise at least a first linear translation direction, a second linear translational direction and a first angular rotational direction.

4. The welding end effector apparatus of claim 1, wherein the welding end effector apparatus further comprises a heating mechanism.

5. The welding end effector apparatus of claim 4, wherein the heating mechanism comprises an electrical heating element or a hot gas source.

6. The welding end effector apparatus of claim 4, wherein the heating mechanism comprises a first hot gas guide configured for delivering hot gas to the welding tip, wherein the plastic weld filler is a plastic weld rod, wherein the welding tip is configured to direct hot gas and the plastic weld rod onto the plastic component for welding the plastic component, or wherein the heating mechanism comprises a second hot gas guide configured for delivering hot gas to the plastic weld supply.

7. The welding end effector apparatus of claim 1, wherein the plastic weld filler supply comprises:
a weld rod feeder for delivering a plastic weld rod to a welding rod guide, comprising:
a toothed shaft configured for moving the plastic weld rod in a first direction towards the welding rod guide;
a motor coupled to the toothed shaft, via a gear train, for turning the toothed shaft; and
a tensioning apparatus comprising one or more force feed rollers configured for applying a predetermined pressure to the plastic weld rod located between the toothed shaft and the one or more force feed rollers; and
wherein the welding rod guide is configured to direct the plastic weld rod into the welding tip.

8. The welding end effector apparatus of claim 7, further comprising:
a cutting mechanism to cut the plastic weld rod, wherein the cutting mechanism comprises:
a cutting body comprising an actuation mechanism, wherein the actuation mechanism comprise at least one of a pneumatic actuation mechanism, an electronic actuation mechanism and an electro-mechanical actuation mechanism; and
one or more cutting blades that are configured to cut the plastic weld rod;
wherein the actuation mechanism is configured to actuate the one or more cutting blades to cut the plastic weld rod; and
wherein the one or more cutting blades are configured to cut the plastic weld rod between a first portion of the plastic weld rod located at the welding rod guide and a second portion of the plastic weld rod located at the weld rod feeder.

9. The welding end effector apparatus of claim 8, wherein the one or more cutting blades are configured to cut the plastic weld rod between the weld rod feeder and the welding tip, or between a first portion of the plastic weld rod located at the welding rod guide and a second portion of the plastic weld rod located at the weld rod feeder.

10. The welding end effector apparatus of claim 7, wherein apparatus comprises a hot gas mechanism configured to deliver hot gas to the welding rod guide.

11. The welding end effector apparatus of claim 1, wherein the apparatus comprises a force sensor configured to:
sense at least one welding parameter comprising welding speed, welding pressure at the welding tip and welding path of the welding tip; and
transmit a feedback signal comprising the at least one welding parameter sensed to a controller device;
wherein the force sensor is configured to sense the at least one welding parameter along a plurality of degrees of freedom.

12. A plastic welding apparatus configured for automated plastic welding, the apparatus comprising:
a robotic arm; and
a welding end effector operatively coupled to the robotic arm, comprising:
a welding tip;
a frame structure supporting a welding tip; and
a plastic weld filler supply configured to supply plastic weld filler for plastic welding;
wherein the welding tip is configured to deposit the plastic weld filler onto a plastic component for welding the plastic component.

13. The plastic welding apparatus of claim 12, further comprising:
a heating mechanism configured for heating the plastic weld filler; and
a temperature sensor configured to transmit a temperature of the heating mechanism or weld filler;
wherein, based on the sensed parameter, the heating mechanism is adjusted to control the temperature.

14. The plastic welding apparatus of claim 13, wherein the plastic weld filler supply comprises:
a weld rod feeder apparatus and the plastic weld filler is a plastic weld rod;
wherein the plastic weld rod is configured to be at least partially deformed by the heating mechanism;
wherein the weld feeder apparatus is configured to deliver the plastic weld rod to the welding tip; and
wherein the welding tip is configured to deposit the at least partially deformed plastic weld rod onto the plastic component for welding the plastic component.

15. The plastic welding apparatus of claim 12, wherein the robotic arm comprises:
a multi-axis robotic arm operatively coupled to the welding end effector, wherein the multi-axis robotic arm is configured to position the welding tip along a plurality of degrees of freedom for automated welding of the plastic component; and
a controller device operatively coupled to the multi-axis robotic arm, wherein the controller device is configured to transmit control instructions to cause the multi-axis robotic arm to move the welding tip along a predetermined path.

16. The plastic welding apparatus of claim 12, further comprising:
a force sensor configured to transmit at least one sensed welding parameter to a controller device;
wherein, based on the at least one sensed parameter, the controller device is configured to transmit control instructions to the multi-axis robotic arm to cause the multi-axis robotic arm to modify at least one of the movement of the welding tip and the position of the welding tip.

17. The plastic welding apparatus of claim 16, wherein, based on the at least one sensed parameter, the controller device is configured to transmit control instructions to the plastic weld supply to cause the plastic weld supply to modify dispensing of the plastic weld filler.

18. A method for plastic welding of a plastic component comprising:
executing, by a controller device having a processing device, computer readable code associated with a welding program for a plastic welding apparatus, wherein executing the computer readable code comprises determining a weld path comprising an origin point and an end point, wherein the plastic welding apparatus comprises a welding end effector operatively coupled to a robotic arm, the welding end effector comprising a welding tip, and a plastic weld filler supply, and wherein the controller device is operatively coupled to the robotic arm and the welding end effector;
welding, by the welding end effector, a plastic component along the weld path based on instructions received from the controller device; and
stopping the welding of the plastic component based on determining that the welding tip is located at the end point of the weld path.

19. The method of claim 18, wherein welding comprises:
positioning, via the robotic arm, the welding tip at the origin position of the weld path;
traversing, via the robotic arm, the welding tip along the weld path; and
dispensing, via the plastic weld filler supply, plastic weld filler from the welding tip onto the plastic component during traversing the weld path, wherein dispensing further comprises heating the plastic weld filler using a heating mechanism of the welding end effector.

20. The method of claim 18, wherein the plastic welding end effector further comprises a force sensor, and wherein the method further comprises:
determining, by the force sensor, a welding parameter during the welding by the welding end effector;
receiving, at the controller device, a feedback signal comprising the welding parameter determined from the force sensor;
processing the feedback signal to determine whether the welding of the plastic component meets desired welding parameters;
in response to determining that the feedback signal does not meet the welding parameters, transmitting control instructions from the controller device to modify the welding of the plastic component, wherein modifying the welding of the plastic component comprises at least one of: (i) traversing the welding tip, via the robotic arm, along a modified weld path, (ii) modifying the dispensing of the plastic weld filler using the plastic weld filler supply, and (iii) modifying the heating the plastic weld filler using the heating mechanism.
